(19) United States
(12) Patent Application Publication
(10) Pub. No.: US 2011/0012730 A1
(43) Pub. Date: Jan. 20, 2011

(54) DOOR NOTIFICATION SYSTEM

(76) Inventors: John Gerard Finch, Livonia, MI (US); Thomas Alan Barnett, Ypsilanti, MI (US); Jeffrey Iott, Monroe, MI (US)

Correspondence Address: Carlson, Gaskey & Olds/Masco Corporation, 400 West Maple Road, Suite 350, Birmingham, MI, 48009, US

(21) Appl. No.: 12/667,949

(22) PCT Filed: Jul. 22, 2008
(86) PCT No.: PCT/US08/70700

§ 371 Date: Jan. 6, 2010

Related U.S. Application Data
(60) Provisional application No. 60/954,007, filed on Aug. 5, 2007.

(51) Int. Cl. G08B 1/08

(52) U.S. Cl. 340/539.14; 340/539.1

(57) ABSTRACT

In one example, a door notification system includes a wireless batteryless switch associated with a door and a receiver coupled to a lighting load and to a sound-emitting load. The receiver is operable to provide a door notification in response to a signal from the wireless batteryless switch. The door notification includes at least one of a flash of the lighting load or a sound from the sound-emitting load. In one example, a door notification system includes a wireless batteryless switch associated with a door and a portable receiver that is operable to plug into an electrical outlet and that includes a built-in sound-emitting load. The portable receiver is operable to activate the sound-emitting load to produce an audio signal in response to a signal from the wireless batteryless switch.

The application claims priority to U.S. Provisional Application No. 60/954,007 which was filed on Aug. 5, 2007.

### BACKGROUND OF THE INVENTION

This application relates to a door notification system, and more specifically to a door notification system including wireless batteryless switching.

Devices such as door bells and door knockers are commonly used to notify a resident of a house that someone wishes to enter the house. However, these devices can be ineffective for certain people, such as the hearing impaired. Additionally, it can be difficult to hear a doorbell or door knocker in a large house if one is located in a remote part of the house.

### SUMMARY OF THE INVENTION

In one example, a door notification system includes a wireless batteryless switch associated with a door and a receiver coupled to a lighting load and to a sound-emitting load. The receiver is operable to provide a door notification in response to a signal from the wireless batteryless switch. The door notification includes at least one of a flash of the lighting load or a sound from the sound-emitting load.

In another example, a door notification system includes a wireless batteryless switch associated with a door and a portable receiver that is operable to plug into an electrical outlet and that includes a built-in sound-emitting load. The portable receiver is operable to activate the sound-emitting load to produce an audio signal in response to a signal from the wireless batteryless switch.

These and other features of the present invention can be best understood from the following specification and drawings, the following of which is a brief description.

### BRIEF DESCRIPTION OF THE DRAWINGS

FIG. 1 schematically illustrates an example wireless batteryless switching application.

FIG. 2 schematically illustrates an example doorbell switch application.

FIG. 3 schematically illustrates an example door knocker switch application.

FIG. 4 schematically illustrates a mobile receiver unit application.

### DETAILED DESCRIPTION OF THE PREFERRED EMBODIMENT

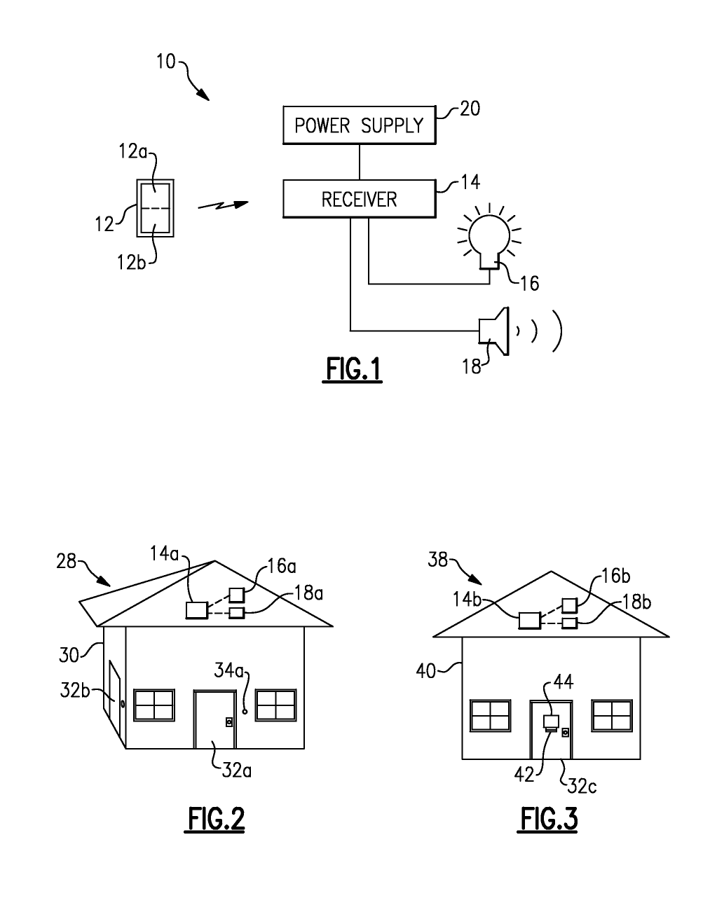

FIG. 1 schematically illustrates an example wireless batteryless switching application 10. A wireless batteryless switch 12 communicates with a receiver 14. In one example, the switch 12 has an upper portion 12a and a lower portion 12b, and when the upper portion 12a is pressed the switch sends a first signal, and when the lower portion 12b is pressed the switch sends a second signal. In one example the first signal is an ON signal and the second signal is an OFF signal. However, it is understood that the switch 12 may only include a single actuable portion and may not include an upper portion 12a and a lower portion 12b. The wireless batteryless switch is self-energizing in that the switch 12 includes an energy harvester operable to harvest energy from an external source, such as a person actuating the switch, or a photovoltaic cell. The receiver 14 is operable to selectively couple at least one of a lighting load 16 or a sound-emitting load 18 to a power supply 20 in response to a signal from the switch 12.

One example wireless batteryless switch is available from EnOcean under Product No. PTM 250 and one example receiver is available from EnOcean under Product No. RCM130C. Although the receiver 14 as shown in FIG. 1 is a multi-channel receiver, it is understood that the receiver 14 could be a single channel receiver and could be coupled to more or less than two items. Also, it is understood that multiple receivers could be used in the switching application 10.

FIG. 2 schematically illustrates an example doorbell switch application 28. A house 30 includes a door 32a, and a wireless batteryless doorbell switch 34a built into a doorbell button and associated with the door 32a. Although the door 32a is shown as an entry door to the house 30, it is understood that other doors could be used, such as a child door, a pet door, a basement door, an elevator roof door, an emergency exit door, or an elderly person door. The switch 34a is batteryless and may be operable to harvest solar energy, or may be operable to harvest mechanical energy from an actuation of the switch 34a. A receiver 14a is coupled to a lighting load 16a and a sound-emitting load 18a. The lighting load 16a may correspond to a standard light within the house 30 that is controlled by the receiver 14a, such as a ceiling light, and may also correspond to a plurality of lights. The sound-emitting load 18a may correspond to a speaker operable to produce an audio signal, such as a doorbell sound. When the receiver 14a receives a signal from the doorbell switch 34a, the receiver 14a uses software to process the signal and provides a door notification by either flashing a light associated with the lighting load 16a or by activating the sound-emitting load 18a to produce a sound. In one example the door notification includes a flash of the lighting load 16a and a sound from the sound-emitting load 18a. Since the receiver 14a is operable to control the standard building lights and is in control of the sound-emitting load 18a, the two can be interconnected in this manner. The house 30 may also include a second door 32b and a second wireless batteryless doorbell switch 34b associated with the second door 32b. The switch 34b could also be operable to activate the lighting load 16a and the sound-emitting load 18a.

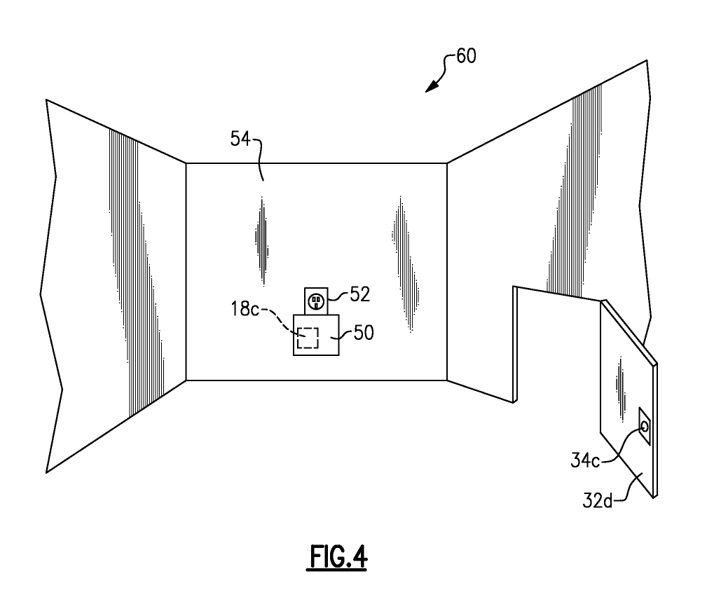

FIG. 3 schematically illustrates an example door knocker switch application 38. A house 40 includes a door 32c and a door knocker switch 42 associated with the door 32c. In this example, the door knocker switch 42 is coupled to a mechanical energy harvester 44 operable to harvest energy from a motion of the door knocker switch 42. One example energy harvester is available from EnOcean under Product No. ECO 100. The door knocker switch 42 may be activated to transmit a signal to the receiver 14b, which is coupled to a lighting load 16b and a sound-emitting load 18b. When the receiver 14b receives a signal from the door knocker switch 42, the receiver 14b uses software to process the signal and provides a door notification, such as flashing the lighting load 16a or activating the sound-emitting load 18a. As in the previous example, the light 16 may be a standard building light, such as a ceiling light.

FIG. 4 schematically illustrates a mobile receiver unit 50. As shown in FIG. 4, the mobile receiver unit 50 may be plugged into an outlet 52 on a wall 54 in a house 60. In this example, the mobile receiver unit 50 acts as a receiver, and a sound-emitting load 18c is built into the mobile receiver unit 50. When a wireless batteryless doorbell switch 34c on a door 32d is activated, the doorbell switch 34c transmits a signal to the mobile receiver unit 50. The mobile receiver unit 50 uses software to process the signal, and then activates the doorbell within the mobile receiver unit 50 in response to the signal. A person may carry the mobile receiver 50 throughout a house and may plug the mobile receiver unit 50 into a different outlet so that even if the person is in a remote location within the house, a sound, such as a doorbell sound, will still be audible when the doorbell switch 34c is activated.

It is understood that the houses 30, 40, 60 may include a plurality of doorbell switches 34, a plurality of door knocker switches 42, a plurality of lighting loads 16, a plurality of sound-emitting loads 18, or a plurality of mobile receivers. The receiver 14 could be programmed to respond to multiple doorbell switches and multiple door knocker switches. If a sound-emitting load 18 was capable of playing different sounds, such as different ring tones, the receiver 14, 50 could be programmed to activate different sounds based upon which switch is activated, or based upon a click pattern from a switch. For example, as shown in FIG. 2, the house 30 has a first doorbell switch 34a and a second doorbell switch 34b. If the sound-emitting load 18a was capable of playing different sounds, the receiver 14a could be programmed to command the sound-emitting load 18a to play a first sound when the first doorbell switch 34a is activated, and to play a second sound when the second doorbell switch 34b is activated.

Also, the receiver 14a could be programmed to provide a first notification in response to a first click pattern from the switch 34a, and could be programmed to provide a second notification in response to a second click pattern from the switch 34a. This would enable a person, such as a homeowner, to provide different click patterns to different individuals so that the person could identify who was at the door based upon the notification.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A door notification system comprising:
a wireless batteryless switch associated with a door; and
a receiver coupled to a lighting load, a sound-emitting load, or both, wherein the receiver is operable to provide a door notification in response to a signal from the wireless batteryless switch, and wherein the door notification includes a flash of the lighting load, a sound from the sound-emitting load, or both.

2. The system of claim 1, wherein the door notification includes a flash of the lighting load and a sound from the sound-emitting load.

3. The system of claim 1, wherein the wireless batteryless switch corresponds to a door knocker and is operable to harvest energy from a movement of the door knocker.

4. The system of claim 1, wherein the wireless batteryless switch corresponds to a doorbell button and is operable to harvest energy from an actuation of the doorbell button.

5. The system of claim 1, wherein the wireless batteryless switch corresponds to a doorbell button and is operable to harvest solar energy.

6. The system of claim 1, wherein the wireless batteryless switch is to be mounted on an exterior of a building and the receiver is to be mounted within an interior of the building.

7. The system of claim 1, wherein the sound-emitting load corresponds to a speaker.

8. The system of claim 1, wherein the sound-emitting load corresponds to a chime.

9. The system of claim 1, wherein the receiver is operable to play a first sound in response to a signal from the wireless batteryless switch, and wherein the receiver is operable to play a second sound in response to a signal from a second wireless batteryless switch.

10. The system of claim 1, wherein the door corresponds to at least one door selected from the group consisting of a child door, a pet door, a basement door, an elevator roof door, an emergency exit door, and an elderly person door.

11. The system of claim 1, wherein the receiver is programmable to provide a first door notification in response to a first click pattern of the wireless batteryless switch, and to provide a second door notification in response to a second click pattern of the wireless batteryless switch.

12. A door notification system comprising:
a wireless batteryless switch associated with a door; and
a portable receiver that is operable to plug into an electrical outlet and that includes a built-in sound-emitting load, wherein the portable receiver is operable to activate the sound-emitting load to produce an audio signal in response to a signal from the wireless batteryless switch.

13. The system of claim 12, wherein the wireless batteryless switch corresponds to a door knocker and is operable to harvest energy from a movement of the door knocker.

14. The system of claim 12, wherein the wireless batteryless switch corresponds to a doorbell button and is operable to harvest energy from an actuation of the doorbell button.

15. The system of claim 12, wherein the wireless batteryless switch corresponds to a doorbell button and is operable to harvest solar energy.

16. The system of claim 12, wherein the wireless batteryless switch is mounted on an exterior of a building and the electrical outlet is within an interior of the building.

17. The system of claim 12, wherein the sound-emitting load corresponds to a speaker.

18. The system of claim 12, wherein the sound-emitting load corresponds to a chime.

19. The system of claim 12, wherein the portable receiver is operable to play a first sound in response to a signal from the wireless batteryless switch, and wherein the portable receiver is operable to play a second sound in response to a signal from a second wireless batteryless switch.

20. The system of claim 12, wherein the door corresponds to at least one door selected from the group consisting of a child door, a pet door, a basement door, an elevator roof door, an emergency exit door, and an elderly person door.
